(19) United States
(12) Patent Application Publication
(10) Pub. No.: US 2025/0062327 A1
(43) Pub. Date: Feb. 20, 2025

(54) COLUMNAR SILICON ANODE HAVING A CARBON FIBER NETWORK THEREON AND LITHIUM-ION BATTERIES INCLUDING THE SAME

(71) Applicant: GM GLOBAL TECHNOLOGY OPERATIONS LLC, Detroit, MI (US)

(72) Inventors: Qili Su, Shanghai (CN); Zhe Li, Shanghai (CN); Meiyuan Wu, Shanghai (CN); Haijing Liu, Shanghai (CN)

(21) Appl. No.: 18/476,826

(22) Filed: Sep. 28, 2023

(30) Foreign Application Priority Data
Aug. 18, 2023 (CN) 202311050357.6

(51) Int. Cl. H01M 4/38; H01M 4/04; H01M 4/583; H01M 10/0525; H01M 10/0568; H01M 10/0569; H01M 10/44

(52) U.S. Cl. CPC H01M 4/386; H01M 4/0404; H01M 4/0428; H01M 4/583; H01M 10/0525; H01M 10/0568; H01M 10/0569; H01M 10/44; H01M 2004/021; H01M 2300/0037

(57) ABSTRACT

Lithium-ion batteries are provided that include a columnar silicon anode including a carbon fiber network on exposed surfaces of the columnar silicon anode. The columnar silicon is formed by plasma vapor deposition. Also disclosed are processes for forming the carbon fiber network, which generally includes spraying a dilute carbon fiber precursor solution including carbon nanotubes, an optional polymeric dispersing agent and a solvent, which is then subjected to facile evaporation at an elevated temperature to remove the solvent and form the carbon fiber network. The carbon fiber network is uniformly and multi-directionally provided on the exposed surfaces of the columnar silicon anode. The presence of the carbon fiber network provides high electronic pathways to enhance battery power capability especially at the higher current rates.

### CROSS REFERENCE TO RELATED APPLICATIONS

The present application claims priority to Chinese Patent Application No. 202311050357.6 filed on Aug. 18, 2023, incorporated herein by reference in its entirety.

### INTRODUCTION

The subject disclosure generally relates to anodes for liquid-based, gel-based, or solid-state lithium-ion batteries, and more particularly, to anodes formed of columnar silicon having a carbon fiber network thereon and lithium-ion batteries including the same.

Lithium-ion batteries including silicon (Si) anodes are a promising energy storage technology due to its high gravimetric theoretical lithium (Li) storage capacity (4200 mAh g⁻¹ for Li₄₄Si), compared to conventionally used graphite anodes (372 mAh g⁻¹), while also having a relatively low discharge voltage (the average delithiation voltage of Si is 0.4 V).

However, the ability of silicon to accommodate large amounts of lithium is known to cause the material to undergo enormous volumetric changes during lithiation and delithiation as occurs during battery cycling, which can be as high as about 400% or more. The induced stress and strain from this volume change can result in electrode fracture and electrical isolation from the underlying current collector during repeated cycling, leading to delamination of the deposited silicon film from the current collector. Further to this, the silicon anode is subject to mechanical fracturing and instability of the solid-electrolyte-interphase (SEI) layers that are formed during the intercalation/de-intercalation processes.

In addition, silicon anodes inherently suffer from a low intrinsic electrical conductivity at room temperature (<10⁻⁵ Siemens per centimeter (S/cm)), which is significantly lower than that of carbon and graphite (10-10⁴ S/cm). When working with liquid electrolyte (or solid electrolyte or gel electrolyte), the low electrical conductivity of silicon can deteriorate rate performance of the lithium-ion battery, hindering its practical high-power application.

Accordingly, it is desirable to mitigate the issues arising from expansion and contraction of the silicon anode during lithium-ion battery cycling to maximize capacity and minimize failure as well as to improve its rate performance for high power applications.

### SUMMARY

In one exemplary embodiment, a columnar silicon anode for a lithium-ion battery includes a plurality of spheroidal-shaped silicon columns; and a carbon fiber network on exposed surfaces of the spheroidal-shaped silicon columns. Silicon in the plurality of spheroidal-shaped silicon columns is greater than 97 weight percent, and the carbon fiber network is about 0.05 weight percent to less than 3 weight percent, wherein the weight percents are based on a total weight of the plurality of spheroidal-shaped silicon columns and the carbon fiber network.

The carbon fiber network is random and multi-directional. In one or more aspects, the carbon fiber network further includes a polymer additive in an amount greater than 0 to 3 weight percent. The carbon fiber network includes carbon nanotubes, wherein the carbon nanotubes have a length greater than about 1 micrometer (μm), a diameter from about 1 nm to about 6 nm and a thickness of less than 0.1 nanometers (nm). The carbon nanotubes can include single walled carbon nanotubes, double walled carbon nanotubes and/or multi-walled nanotubes. In some aspects, the carbon fiber network includes one or more carbon additive materials.

The plurality of spheroidal-shaped silicon columns can be deposited onto an anode current collector by DC magnetron sputtering. Each one of the plurality of spheroidal-shaped silicon columns includes a and b dimensions having lengths within a range of about 0.5 to about 40 micrometers (μm). The columnar silicon anode has an areal capacity of about 0.5 to about 20 milliampere hours per square centimeter. The lithium-ion battery including the columnar silicon anode can be used with liquid based, solid-based or gel based electrolytes.

In one or more embodiments, a process for forming a carbon fiber network on a columnar silicon anode for a lithium-ion battery includes providing a columnar silicon anode on an anode current collector, wherein the columnar silicon anode includes a plurality of spheroidal-shaped silicon columns deposited onto the anode current collector by plasma vapor deposition. A carbon fiber precursor solution having a solids content less than 10 weight precent is deposited onto exposed surfaces of the columnar silicon anode. The carbon fiber precursor solution includes carbon nanotubes, a polymeric dispersing agent, and a solvent. The deposited carbon fiber precursor solution, the columnar silicon anode, and the anode current collector is subjected to an elevated temperature for a period of time effective to evaporate the solvent and form the carbon fiber network on the exposed surfaces, wherein the carbon fiber network is random and multi-directional and is greater than 0 to less than 3 weight percent based on a total weight of the carbon fiber network and the columnar silicon anode. The columnar silicon anode comprises silicon in an amount greater than 97 weight percent based on the total weight of the carbon fiber network and the columnar silicon anode.

The elevated temperature can be at 80° C. to 90° C. and the solvent can include water, or N-methyl-2-pyrrolidone.

The anode current collector has a surface roughness Rz in a range from 0.1 μm to 12 μm.

The polymeric dispersing agent includes poly(vinylidene fluoride) (PVDF), poly(vinylidene fluoride-co-hexafluoropropylene) (PVDF-HFP), poly(tetrafluoroethylene) (PTFE), sodium carboxymethyl cellulose (CMC), styrene-butadiene rubber (SBR), nitrile butadiene rubber (NBR), or styrene ethylene butylene styrene copolymer (SEBS). The carbon nanotubes have a diameter from about 1 to about 6 nanometers (nm), a thickness less than 0.1 nm, and a length greater than 1 μm. The carbon fiber precursor solution can further include a carbon material comprising acetylene black, graphene, and/or graphite.

In one or more embodiments, a rechargeable lithium-ion battery includes a cathode current collector having a thickness of about 4 to about 30 μm externally connected to a load, the cathode current collector comprising aluminum; a cathode on the cathode current collector; an anode current collector having a thickness of about 4 to about 30 μm externally connected to a load, wherein the anode current collector is made of one or more materials selected from a group consisting of copper, stainless steel, nickel, iron, titanium, tin (Sn), and alloys thereof, and wherein the anode current collector has a surface roughness Rz in a range from 0.1 μm to 12 μm; a columnar silicon anode on the anode current collector including a plurality of spheroidal-shaped silicon columns and a carbon fiber network on exposed surfaces of the spheroidal-shaped silicon columns.

The columnar silicon anode is deposited by plasma vapor deposition and has a thickness in a range from 1 μm to about 80 μm, wherein the columnar silicon anode includes silicon in an amount greater than 97 weight percent, and wherein the columnar silicon anode has an areal capacity of about 0.5 to about 20 mAh/cm².

A porous separator is intermediate the cathode and the columnar silicon anode.

In one or more aspects, the lithium-ion battery can further include a liquid electrolyte in the cathode, the columnar silicon anode and the porous separator, the liquid electrolyte includes a lithium salt and an organic solvent, wherein the liquid electrolyte includes a lithium salt, an organic solvent, and an optional additive, wherein the lithium salts comprise LiPF₆, LiBF₄, lithium bis(oxalato) borate, LIN(CF₃SO₂)₂, LIN(C₂FsSO₂)₂, LiAsF₆, LIC(CF₃SO₂)₃, LiClO₄, Li₁₊ₓAlₓTi₂₋ₓ(PO₄)₃, and LiTFSI, and wherein the organic solvent includes ethylene carbonate, diethyl carbonate, propylene carbonate, fluoroethylene carbonate (FEC), and combinations thereof.

The separator is a solid electrolyte and is in the cathode and the columnar silicon anode, wherein the solid electrolyte is selected from a group consisting of pseudobinary sulfide, pseudoternary sulfide, pseudoquaternary sulfide, halide-based solid electrolyte, and hydride-based solid electrolyte.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 schematically illustrates a columnar silicon anode layer including a spiderweb-like carbon network thereon on a copper current collector in accordance with one or more embodiments of the present disclosure;

FIG. 2 schematically illustrates a single silicon column in accordance with one or more embodiments of the present disclosure;

FIG. 3 is a top-down scanning electron micrograph depicting a silicon anode columnar surface including the spiderweb-like carbon fiber network thereon in accordance with one or more embodiments of the present disclosure;

FIG. 4 schematically illustrates a liquid based electrolytic lithium-ion battery structure including a silicon anode in accordance with one or more embodiments of the present disclosure;

FIG. 5 graphically illustrates room temperature cycling for a lithium-ion battery construction including a columnar silicon anode with and without the spider web-like carbon fiber network in accordance with one or more embodiments of the present disclosure;

FIG. 6 graphically illustrates rate performance for a lithium-ion battery construction including a columnar silicon anode with and without the spider web-like carbon fiber network in accordance with one or more embodiments of the present disclosure;

FIG. 7 graphically illustrates discharge curve for a lithium-ion battery construction including a columnar silicon anode with and without the spider web-like carbon fiber network is in accordance with one or more embodiments of the present disclosure; and

FIG. 8 schematically illustrates a solid-state electrolytic battery structure including a silicon anode in accordance with one or more embodiments of the present disclosure.

### DETAILED DESCRIPTION

The following description is merely exemplary in nature and is not intended to limit the present disclosure, its application or uses.

In accordance with exemplary embodiments, liquid-based or solid-state lithium-ion battery constructions include a columnar silicon anode having a spiderweb-like carbon fiber network thereon are disclosed. The presence of the spiderweb-like carbon fiber network on the columnar silicon anode, which is highly conductive, enhances battery power capability especially at the higher current rates. In addition, the presence of the spiderweb-like carbon fiber network can serve as a protective layer for the columnar silicon anode of the lithium-ion battery to mitigate silicon pulverization that can occur during cycling because of volumetric expansion and contraction, which serves to effectively enhance battery cyclability and operating lifetimes. Consequently, the columnar silicon anode including the spiderweb-like carbon fiber network can advantageously be implemented in lithium-ion batteries for high power and high energy applications.

Conventional techniques related to the lithium-ion battery fabrication may or may not be described in detail herein. Moreover, the various tasks and process steps described herein can be incorporated into a more comprehensive procedure or process having additional steps or functionality not described in detail herein. In particular, various steps in the lithium-ion battery fabrication process are well known and so, in the interest of brevity, many conventional steps will only be mentioned briefly herein or will be omitted entirely without providing the well-known process details.

Spatially relative terms, e.g., “beneath,” “below,” “lower,” “above,” “upper,” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device can be otherwise oriented (rotated 90 degrees or at other orientations) and the spatially relative descriptors used herein interpreted accordingly.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects. Additionally, the terms “upper”, “lower”, “top”, “bottom”, “left,” and “right,” and derivatives thereof shall relate to the described structures, as they are oriented in the drawing figures. The same numbers in the various figures can refer to the same structural component or part thereof.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

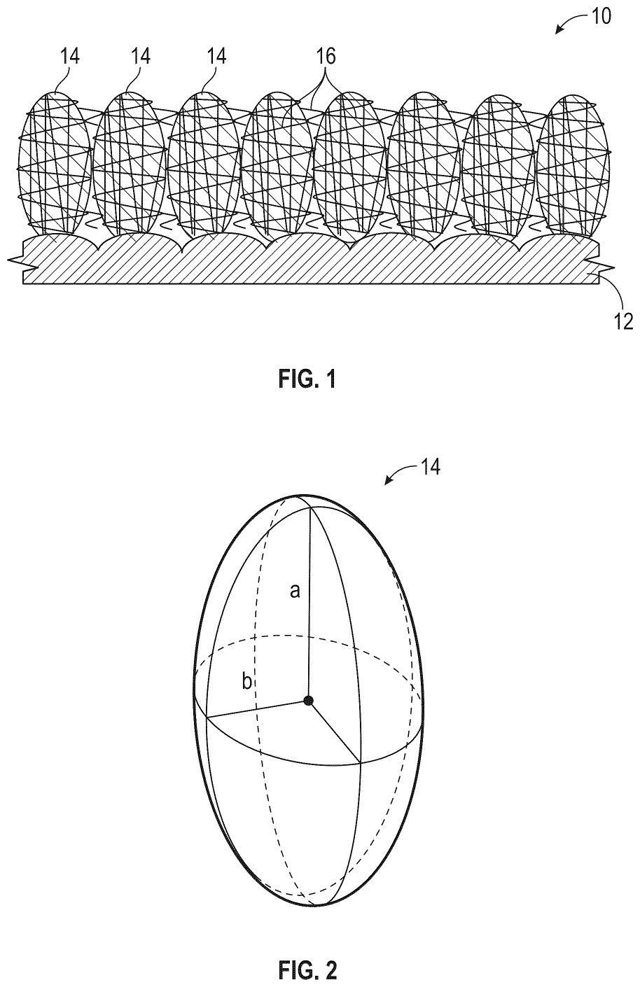

Referring now to FIG. 1, there is schematically shown a cross-sectional view of a columnar silicon anode 10 in accordance with the present disclosure provided on an anode current collector 12. Anode as well as cathode current collectors for lithium-ion batteries, in general, are selected to be electrochemically stable against oxidation and reduction environments during battery charging and discharging. The columnar silicon anode 10 includes a plurality of silicon columns 14 and a spiderweb-like carbon fiber network 16 formed on exposed surfaces of each silicon column 14 and bridging adjacent silicon columns 14. The silicon columns 14 are generally spheroidal-shaped columnar structures that provide a high interface area to facilitate charge transfer and can have low porosity to increase energy density. The spiderweb-like carbon fiber network 16 deposited onto the silicon columns 14 has a much higher electronic conductivity than that of a silicon semiconductor, and for high power silicon anodes provides favorable electronic conducting pathways.

As shown in FIG. 2, the a and b dimensions of a spheroidal-shaped silicon column 14 generally have lengths within a range of about 0.5 to about 40 micrometers (μm). By way of example, the a dimension can have a length dimension of 3.5 μm and the b dimension can have a length dimension of 3.0 μm. Depending on the deposition parameters, the areal capacity provided by a columnar silicon anode including the layer of silicon columns 14 can range from 0.5 to about 20 milliampere hours per square centimeter (mAh/cm²). In one or more embodiments, the columnar silicon anode is configured to provide an areal capacity of about 2 to about 4 mAh/cm².—In one or more embodiments, the resulting silicon columns 14 are greater than about 99 weight percentage (wt %) silicon.

Reference to the term “spiderweb-like” is not intended to infer a particular shape and configuration to the spiderweb-like carbon fiber network 16 on the silicon columns 14. The spiderweb-like carbon fiber network 16 is a generally a non-repeating pattern of randomly deposited carbon fibers and non-directional to provide strength and reinforcement in multiple directions. In one or more embodiments, the spiderweb-like carbon fiber network 16 is greater than about 0.05 weight percent (wt %) to less than about 3 wt % based on a total weight of the silicon columns 14 and the spiderweb-like carbon fiber network 16.

In one or more embodiments, the anode current collector 12 is roughened to increase its surface area and improve adhesion for attachment and growth of the spheroidal-shaped silicon columns 14 thereon. In one or more embodiments, the anode current collector 12 has a surface roughness (Rz) in a range from about 0.1 microns (μm) to about 12 μm. The anode current collector 12 can have a thickness of about 4 μm to about 30 μm and can be in the form a foil. By way of example, the anode current collector 12 can have a thickness of about 14 μm. The anode current collector 12 is made of one or more materials selected from the group consisting of copper, stainless steel nickel iron, titanium, tin, and alloys thereof. In other embodiments, the current collector is a coated foil of graphene or carbon coated stainless steel foil.

The process of forming the columnar silicon anode 10 including a plurality of silicon columns 14 and the spiderweb-like carbon fiber network 16 thereon generally includes cleaning the surface of the anode current collector 12 with a suitable solvent such as isopropyl alcohol, for example, to remove any contaminants and oxides. The surface is then rinsed with distilled water and dried.

The plurality of silicon columns 14 can be deposited onto the cleaned anode current collector 12 using plasma vapor deposition (PVD). PVD generally includes depositing silicon onto a substrate (e.g., anode current collector 12) via evaporation or sputtering of a silicon target material. By way of example, the PVD process can be a pulsed direct current (DC) magnetron sputtering process in an inert atmosphere using a silicon target (e.g., n-type; 99.995%). During sputtering, silicon is ejected from the silicon target material and deposited onto the anode current collector 12. As is generally known in the art, the plurality of silicon columns 14 (i.e., columnar silicon structure) can be formed by controlling the deposition parameters such as temperature, deposition rate, gas composition, and the like. The resulting columnar silicon structure can be annealed to remove any residual stress and promote further growth of the columnar structures.

Once the plurality of silicon columns 14 is formed on the anode current collector 12, the spiderweb-like carbon fiber network 16 is then deposited thereon by mixing a dilute precursor solution including carbon nanotubes, a polymeric dispersing agent, and a processing solvent such as water, N-methyl-2-pyrrolidone, or like solvent in which the polymeric dispersing agent is solubilized. The total solid content (carbon nanotube and polymeric dispersing agent) within the precursor solution is generally low. In one or more embodiments, the total solid content is less than 10 wt %. In one or more other embodiments, the total solid content is less than 3 wt %, and in still one or more embodiments, the total solid content is less than 1 wt %. The precursor solution can be sprayed onto the plurality of silicon columns 14 and subsequently exposed to facile solvent evaporation at elevated temperatures of about 80° C. to 90° C., for example, for a period of time effective to completely remove the solvent. Once the solvent is removed, the spiderweb-like carbon fiber network 16 is formed. As noted above, in one or more embodiments, the spiderweb-like carbon network 16 is greater than 0.05 to less than 3 weight percent based on a total weight of the plurality of silicon columns 14 and spiderweb-like carbon fiber network 16. The amount of silicon in the columnar silicon anode 10 is greater than 97 wt % based on a total weight of the plurality of silicon columns 14 and spiderweb-like carbon fiber network 16. The amount of carbon deposited during formation of the spiderweb-like carbon fiber network can be readily determined using thermogravimetric analysis, for example, which is an analytical technique that includes monitoring weight change upon application of heat and/or pyrolysis.

In one or more embodiments, the spiderweb-like carbon fiber network 16 is formed from carbon nanotubes (CNT), which can include single walled carbon nanotubes (SWCNT), double walled carbon nanotubes (DWCNT), multi-walled carbon nanotubes (MWCNT) or combinations thereof. Carbon nanotubes, in general, are cylindrical carbon structures with diameters on the nanometer (nm) scale (typically a few nanometers) and lengths that can range from micrometers to millimeters. SWCNTs specifically refer to nanotubes consisting of a single layer of graphene rolled into a seamless cylinder whereas DWCNTs include concentric cylindrical two layers and multi-walled CNTs refer to more than two concentric cylindrical layers. Suitable SWCNTs, DWCNTs, and multi-walled carbon nanotubes for forming the spiderweb-like carbon fiber network generally have a length greater than about 1 micrometer (μm), a diameter from about 1 nm to about 6 nm and a thickness of less than 0.1 nanometers (nm), although greater or lesser diameters and thicknesses can be used. Alternatively, vapor grown carbon fibers having the above noted dimensions can be used. In one or more embodiments, blends of the carbon nanotubes can be mixed with other types of carbon additive materials in the precursor solution during formation of the spiderweb-like carbon fiber network, (e.g., Super P™ commercially available from TIMCAL, Ketjenblack, a type of acetylene black commercially available from the Cabot Corporation, acetylene black, graphite conductive agents such as KS-6, KS-15, S—O, SEG-6, and the like, and graphene).

Exemplary polymer dispersing agents include, but are not limited to, poly(vinylidene fluoride) (PVDF), poly(vinylidene fluoride-co-hexafluoropropylene) (PVDF-HFP), poly(tetrafluoroethylene) (PTFE), sodium carboxymethyl cellulose (CMC), styrene-butadiene rubber (SBR), nitrile butadiene rubber (NBR), styrene ethylene butylene styrene copolymer (SEBS) and the like. The polymer dispersing agent assists in dispersity of the carbon nanotubes (i.e., prevents aggregation) in the precursor solution.

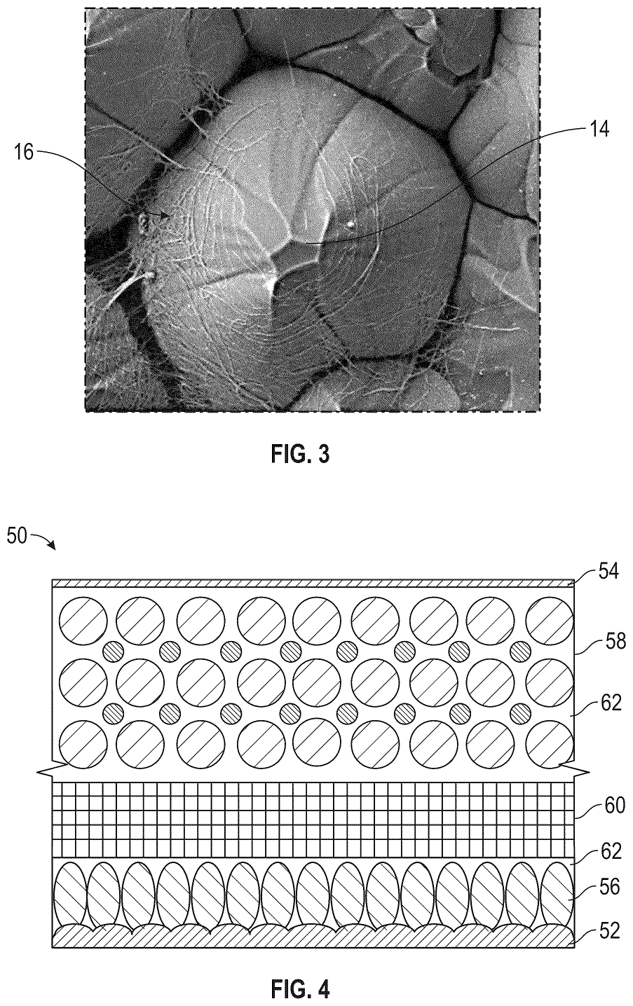

FIG. 3 is a scanning electron micrograph depicting a top surface of an exemplary columnar silicon anode 14 including the spiderweb-like carbon fiber network 16 thereon. As shown, the spiderweb-like carbon fiber network is randomly formed directly on the exposed surfaces of each silicon column and also bridges surfaces on adjacent silicon columns. The spiderweb-like carbon fiber network is random and multi-directional.

FIG. 4 illustrates an exemplary liquid-based lithium-ion battery cell 50. The lithium-ion battery cell 50, also referred to as an electrochemical cell, includes a single cell but may also include more than one cell. The lithium-ion battery cell 50 generally includes an anode current collector 52, which is typically a copper current collector, and a cathode current collector 54, which is typically an aluminum current collector. The anode and cathode current collectors 52, 54, respectively, are externally connectable to a load or to a recharging source (not shown) as appropriate. A columnar silicon anode including the spiderweb-like carbon fiber network thereon 56 overlays anode current collector 52 and a lithium-containing metal oxide-based cathode 58 overlays cathode current collector 54. A porous plastic spacer or separator 60 is provided between the columnar silicon anode including the spiderweb-like carbon fiber network thereon 56 and the cathode 58. A liquid electrolyte 62 is dispersed within the porous plastic spacer or separator 60, the silicon anode layer 56 and the lithium-containing metal oxide-based composite cathode layer 58.

The lithium-containing metal oxide-based cathode 58 generally includes an active cathode material in a range from 30 to 98 wt %, a conductive additive in a range from 0 to 30 wt %, and a binder in a range from 0 to 20 wt %, wherein the weight percentages are based on a total weight of the lithium-containing metal oxide-based cathode 58. The lithium-containing metal oxide-based cathode can have a thickness in a range from about 10 μm to about 500 μm, e.g., 40 μm.

Exemplary active cathode materials include, without limitation, lithium containing metal oxide-based composite materials such as lithium cobalt oxide (LCO), lithium nickel manganese cobalt oxide (NMC), lithium iron phosphate (LFP), lithium manganese oxide-lithium manganese iron phosphate (LMO-LMFP), lithium manganese oxide (LMO), lithium nickel cobalt aluminum oxide (NCA), lithium titanate (LTO), and the like.

The conductive additive includes one or more materials selected from a group consisting of carbon black, graphite, graphene, graphene oxide, Super P(SP), acetylene black, carbon nanofibers, carbon nanotubes, and other electronically conductive additives.

Examples of binders include one or more materials selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS) and other suitable binders.

An exemplary separator 60 according to one or more embodiments may include polyethylene (PE), polypropylene (PP), polyacetylene, combinations thereof, or the like. The separator generally has a porosity of about 40 to about 60% and a thickness of about 8 to about 20 μm.

The liquid electrolyte 62 is a liquid medium that enables movement of lithium ions between the lithium-containing metal oxide-based cathode 58 and the columnar silicon anode including the spiderweb-like carbon fiber network thereon 56. The liquid electrolyte 62 generally includes a lithium salt, organic solvent, and additives. Examples of suitable salts include LiPF₆, LiBF₄, lithium bis(oxalato) borate, LiN(CF₃SO₂)₂, LiN(C₂FsSO₂)₂, LiAsF₆, LiC(CF₃SO₂)₃, LiClO₄, Li₁₊ₓAlₓTi₂₋ₓ(PO₄)₃, and LiTFSI. Examples of organic solvents ethylene carbonate, diethyl carbonate, propylene carbonate, fluoroethylene carbonate (FEC), and combinations thereof.

When liquid-based lithium-ion battery cell 50 is fully charged, lithium ions will have been transported from the lithium-containing metal oxide-based cathode layer 58 via the liquid electrolyte 62 into the columnar silicon anode including the spiderweb-like carbon fiber network thereon 56 (including the spiderweb-like carbon fiber network thereon) to create a lithium silicon compound such as Li, Sis, which has a maximum capacity considerably higher than the maximum capacity of a graphite anode.

Electrochemical properties of a liquid-based lithium-ion battery cell including a columnar silicon anode with and without the spiderweb-like carbon fiber network were evaluated with the results graphically shown in FIGS. 6-8. In the following experiments, the lithium-ion battery cell included a copper current collector at a thickness of 20 μm, the same columnar silicon anode with and without the spiderweb-like carbon fiber network, a separator having a porosity of 45% formed of polyacetylene and polypropylene at a thickness of 20 μm; a cathode formed of LMFP/LMO/SP/PVDF-46/46/4/4 (wt %) with a loading of about 1.1 mAh/cm², and an aluminum cathode current collector at a thickness of 20 μm.

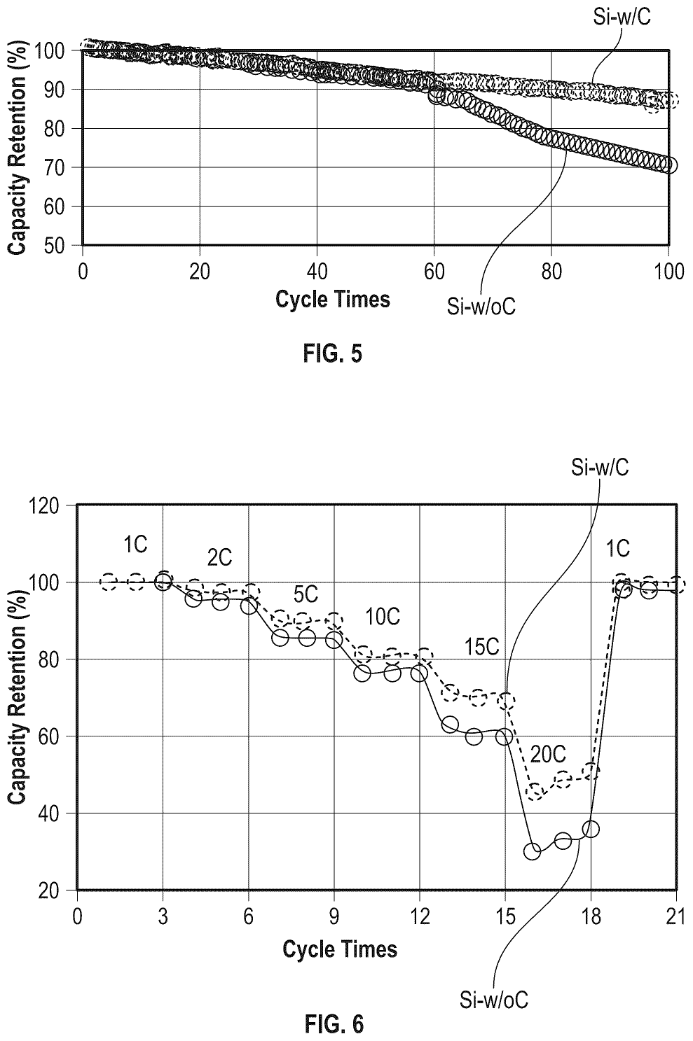

In FIG. 5, cycle performance at room temperature was evaluated for the lithium-ion battery constructions including the silicon anode without the spiderweb-like carbon network (Si-w/oC) and the constructions including the silicon anode with the spiderweb-like carbon network (Si-w/C). After about 60 cycles, the lithium-ion battery including the Si-w/oC anode began to exhibit a loss in the percentage of capacity retention compared to the same lithium-ion battery construction including the Si-w/C anode that was exacerbated after 100 cycles. The capacity retention percentage of the Si-w/oC significantly worsened to about 70% capacity retention after 100 cycles and is believed to be attributed to loss of electronic contact due to volumetric expansion. In contrast, the capacity retention percentage for the lithium-ion battery including the Si-w/C anode was substantially linear and was about 88% after 100 cycles, which advantageously demonstrated improved electronic conduction and protection from the volumetric expansion during charging resulting from the presence of the spiderweb-like carbon fiber network.

FIG. 6 graphically illustrates rate performance for lithium-ion battery constructions including the silicon anode without the spiderweb-like carbon network (Si-w/oC) and constructions including the silicon anode with the spiderweb-like carbon network (Si-w/C). Discharge rate performance in lithium-ion batteries generally refers to how well the battery can deliver charge at different rates or current levels, which is often referred to as the C-current rate (i.e., it is a measure of how quickly the battery can discharge while maintaining its capacity and performance). The C-rate represents the current at which a battery is discharged relative to its rated capacity. For example, a battery discharged at a 1 C-rate would take one hour to fully discharge, while a 2 C-rate would discharge the battery in half an hour. Higher C-rates, such as 5 C or 10 C, represent much faster rates of discharge. As graphically shown, the percentage capacity retention was measured for 3 cycles at the different rates as shown. At the higher C-rates, the capacity retention percentage was markedly decreased for the lithium-ion battery containing the Si-w/oC anode than it was for the lithium-ion battery containing the Si-w/C anode, wherein the differential was higher as the C-rate was increased. Clearly, the spiderweb-like carbon fiber network on the columnar silicon anode enhances the battery discharge power capability, especially at the 15 C-rate and 20 C-rate as graphically shown.

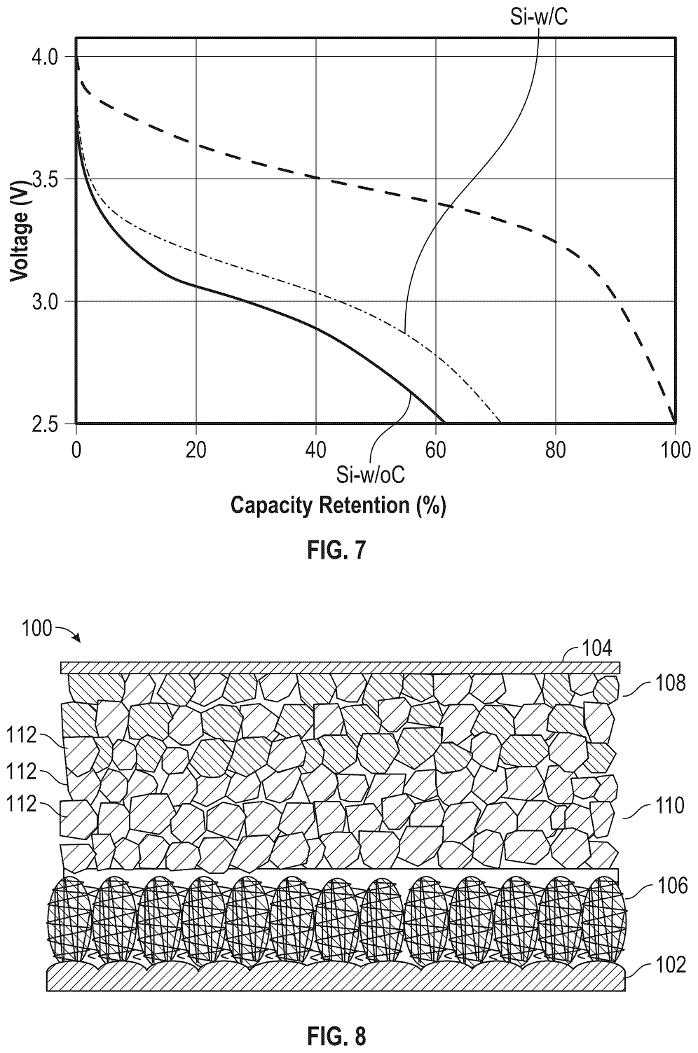

In FIG. 7, the discharge curves at the 15 C-rate are graphically shown for the lithium-ion battery constructions including the silicon anode without the spiderweb-like carbon network (Si-w/oC) and constructions including the silicon anode with the spiderweb-like carbon network (Si-w/C). The discharge curve of a lithium-ion battery refers to the relationship between the battery's voltage and its remaining capacity during a discharge cycle. It illustrates how the battery's voltage decreases as the capacity is depleted. As shown, capacity retention was much higher in the lithium-ion battery including the Si-w/C anode.

FIG. 8 illustrates a solid-state lithium-ion battery cell 100 in accordance with one or more other embodiments. The solid-state lithium-ion battery 100 includes an anode current collector 102 and a cathode current collector 104. A columnar silicon anode including the spiderweb-like carbon fiber network 106 as previously described is provided on the anode current collector 102 and a cathode 108 is provided on the cathode current collector 104. A separator 110 formed of a solid electrolyte 112 is intermediate the columnar silicon anode including the spiderweb-like carbon fiber network 106 and the cathode 108, which can also include solid electrolyte 112.

The cathode 108 in the solid-state battery 100 can include solid electrolyte (in a range from 1 to 50 wt %), cathode active material in a range from 30 to 98 wt %, conductive additive in a range from 0 to 30 wt %, and a binder in a range from 0 to 20 wt %. In some examples, the cathode 108 has a thickness in a range from 10 μm to 500 μm (e.g., 40 μm).

In some examples, the cathode active material includes one or more materials selected from a group consisting of a rock salt layered oxide, spinel, a polyanion cathode, a lithium transition-metal oxide, a surface-coated and/or doped cathode material, and a low voltage cathode material.

Examples of rock salt layered oxides include LiCoO₂, LiNixMnyCo_{1-x-y}O₂, LiNiₓMn_{y}Al_{1-x-y}O₂, LiNiₓMn₁₋ₓO₂, Li₁₊ₓMO₂. Examples of spinel include LiMn₂O₄, LiNi_{0.5}Mn_{1.5}O₄. Examples of polyanion cathodes include LiV₂(PO₄)₃. Examples of surface-coated and/or doped cathode materials include LiNbO₃-coated LiMn₂O₄, Li₂ZrO₃ or Li₃PO₄-coated LiNiₓMn_{y}Co_{1-x-y}O₂, and Al-doped LiMn₂O₄. Examples of low voltage cathode materials include lithiated metal oxide/sulfide (e.g., LiTiS₂), lithium sulfide, and sulfur.

In some examples, the conductive additive includes one or more materials selected from a group consisting of carbon black, graphite, graphene, graphene oxide, Super P, acetylene black, carbon nanofibers, carbon nanotubes, and other electronically conductive additives. Examples of binder include one or more materials selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS) and other suitable binders.

In some examples, the solid electrolyte in the separator layer and/or cathode electrode is selected from a group consisting of pseudobinary sulfide, pseudoternary sulfide, pseudoquaternary sulfide, halide-based solid electrolyte, and hydride-based solid electrolyte.

Examples of pseudobinary sulfide include Li₂S—P₂S₅ system (Li₃PS₄, Li₇P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₃ system, Li₂S—Ga₂S₃ system, Li₂S—P₂S₃ system, Li₂S—Al₂S₃ system. Examples of pseudoternary sulfide include Li₂O—Li₂S—P₂S₅ system, Li₂S—P₂S₅—P₂O₅ system, Li₂S—P₂S₅—GeS₂ system (Li_{3.25}Ge_{0.25}P_{0.75}S₄ and Li₁₀GeP₂S₁₂), Li₂S—P₂S₅—LiX(X ═F, Cl, Br, I) system (Li₆PSsBr, Li₆PSsCl, L₇P₂S₈I and Li₄PS₄I), Li₂S—As₂S₅—SnS₂ system (Li_{3.833}Sn_{0.833}As_{0.166}S₄), Li₂S—P₂S₅—Al₂S₃ system, Li₂S—LiX—SiS₂ (X═F, Cl, Br, I) system, and 0.4LiI·0.6Li₄SnS₄ and Li₁₁iSi₂PS₁₂. Examples of pseudoquaternary sulfide include Li₂O—Li₂S—P₂S₅—P₂O₅ system, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S₁₂.

Examples, of halide-based solid electrolyte include Li₃YCl₆, Li₃InCl₆, Li₃YBr₆, LiI, Li₂CdCl₄, Li₂MgCl₄, Li₂CdI₄, Li₂ZnI₄, Li₃OCI. Examples of hydride-based solid electrolyte include LiBH₄, LiBH₄—LiX(X═Cl, Br or I), LiNH₂, Li₂NH, LiBH₄—LiNH₂, Li₃AlH₆. In other examples, other types of solid electrolyte with low grain-boundary resistance can be used.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A columnar silicon anode for a lithium-ion battery comprising:
a plurality of spheroidal-shaped silicon columns; and
a carbon fiber network on exposed surfaces of the spheroidal-shaped silicon columns;
wherein silicon in the plurality of spheroidal-shaped silicon columns is greater than 97 weight percent, and wherein the carbon fiber network is about 0.05 weight percent to less than 3 weight percent, wherein the weight percents are based on a total weight of the plurality of spheroidal-shaped silicon columns and the carbon fiber network.

2. The columnar silicon anode of claim 1, wherein the carbon fiber network is random and multi-directional.

3. The columnar silicon anode of claim 1, wherein the carbon fiber network further comprises a polymer additive in an amount greater than 0 to 3 weight percent.

4. The columnar silicon anode of claim 1, wherein each one of the plurality of spheroidal-shaped silicon columns includes a and b dimensions having lengths within a range of about 0.5 to about 40 micrometers (μm).

5. The columnar silicon anode of claim 1, wherein the lithium-ion battery including the columnar silicon anode comprises a liquid-based, a solid-state or a gel based electrolyte.

6. The columnar silicon anode of claim 1, wherein the carbon fiber network comprises carbon nanotubes, wherein the carbon nanotubes have a length greater than about 1 micrometer (μm), a diameter from about 1 nm to about 6 nm and a thickness of less than 0.1 nanometers (nm).

7. The columnar silicon anode of claim 6, wherein the carbon nanotubes comprise single walled carbon nanotubes, double walled carbon untroubled and/or multi-walled nanotubes.

8. The columnar silicon anode of claim 6, wherein the carbon fiber network further comprises one or more carbon additive materials.

9. The columnar silicon anode of claim 1, wherein the plurality of spheroidal-shaped silicon columns is deposited onto an anode current collector by DC magnetron sputtering.

10. The columnar silicon anode of claim 1, wherein the columnar silicon anode has an areal capacity of about 0.5 to about 20 milliampere hours per square centimeter.

11. A process for forming a carbon fiber network on a columnar silicon anode for a lithium-ion battery, the process comprising:
providing a columnar silicon anode on an anode current collector, wherein the columnar silicon anode comprises a plurality of spheroidal-shaped silicon columns deposited onto the anode current collector by plasma vapor deposition;
depositing a carbon fiber precursor solution having a solids content less than 10 weight precent onto exposed surfaces of the columnar silicon anode, the carbon fiber precursor solution comprising carbon nanotubes, a polymeric dispersing agent, and a solvent; and
subjecting the deposited carbon fiber precursor solution, the columnar silicon anode, and the anode current collector to an elevated temperature for a period of time effective to evaporate the solvent and form the carbon fiber network on the exposed surfaces,
wherein the carbon fiber network is random and multi-directional and is greater than 0 to less than 3 weight percent based on a total weight of the carbon fiber network and the columnar silicon anode, and
wherein the columnar silicon anode comprises silicon in an amount greater than 97 weight percent based on the total weight of the carbon fiber network and the columnar silicon anode.

12. The process of claim 11, wherein the elevated temperature is at 80° C. to 90° C.

13. The process of claim 11, wherein the solvent comprises water, or N-methyl-2-pyrrolidone.

14. The process of claim 11, wherein the anode current collector has a surface roughness Rz in a range from 0.1 μm to 12 μm.

15. The process of claim 11, wherein the polymeric dispersing agent comprises poly(vinylidene fluoride) (PVDF), poly(vinylidene fluoride-co-hexafluoropropylene) (PVDF-HFP), poly(tetrafluoroethylene) (PTFE), sodium carboxymethyl cellulose (CMC), styrene-butadiene rubber (SBR), nitrile butadiene rubber (NBR), or styrene ethylene butylene styrene copolymer (SEBS).

16. The process of claim 11, wherein the carbon nanotubes have a diameter from about 1 to about 6 nanometers (nm), a thickness less than 0.1 nm, and a length greater than 1 μm.

17. The process of claim 11, wherein the carbon fiber precursor solution further comprises a carbon material comprising acetylene black, graphene, and/or graphite.

18. A rechargeable lithium-ion battery comprising:
a cathode current collector having a thickness of about 4 to about 30 μm externally connected to a load, the cathode current collector comprising aluminum;
a cathode on the cathode current collector;
an anode current collector having a thickness of about 4 to about 30 μm externally connected to a load, wherein the anode current collector is made of one or more materials selected from a group consisting of copper, stainless steel, nickel, iron, titanium, tin (Sn), and alloys thereof, and wherein the anode current collector has a surface roughness Rz in a range from 0.1 μm to 12 μm;
a columnar silicon anode on the anode current collector comprising a plurality of spheroidal-shaped silicon columns and a carbon fiber network on exposed surfaces of the spheroidal-shaped silicon columns, wherein the columnar silicon anode is deposited by plasma vapor deposition and has a thickness in a range from 1 μm to about 80 μm, wherein the columnar silicon anode comprises silicon in an amount greater than 97 weight percent, and wherein the columnar silicon anode has an areal capacity of about 0.5 to about 20 mAh/cm²; and
a porous separator intermediate the cathode and the columnar silicon anode.

19. The lithium-ion battery of claim 18, further comprising a liquid electrolyte in the cathode, the columnar silicon anode and the porous separator, the liquid electrolyte comprising a lithium salt and an organic solvent, wherein the liquid electrolyte comprises a lithium salt, an organic solvent, and an optional additive, wherein the lithium salts comprise LiPF₆, LiBF₄, lithium bis(oxalato) borate, LIN(CF₃SO₂)₂, LIN(C₂FsSO₂)₂, LiAsF₆, LiC(CF₃SO₂)₃, LiClO₄, Li₁₊ₓAlₓTi₂₋ₓ(PO₄)₃, and LiTFSI, and wherein the organic solvent comprises ethylene carbonate, diethyl carbonate, propylene carbonate, fluoroethylene carbonate (FEC), and combinations thereof.

20. The lithium-ion battery of claim 18, wherein the separator is a solid electrolyte and is in the cathode and the columnar silicon anode, wherein the solid electrolyte is selected from a group consisting of pseudobinary sulfide, pseudoternary sulfide, pseudoquaternary sulfide, halide-based solid electrolyte, and hydride-based solid electrolyte.
